(19) United States
(12) Patent Application Publication
(10) Pub. No.: US 2025/0335109 A1
(43) Pub. Date: Oct. 30, 2025

(54) SYSTEMS AND METHODS OF RESOURCE UTILIZATION IN A STORAGE SYSTEM

(71) Applicant: Dell Products L.P., Round Rock, TX (US)

(72) Inventors: Jayanth Shimoga Devappa, Bangalore (IN); Bharadwaj R. Sathavalli, Bangalore (IN); Sreepathi Haleupparahalli, Bangalore (IN)

(73) Assignee: Dell Products L.P., Round Rock, TX (US)

(21) Appl. No.: 18/645,666

(22) Filed: Apr. 25, 2024

(51) Int. Cl. G06F 3/06

(52) U.S. Cl. CPC G06F 3/0631; G06F 3/0604; G06F 3/0665; G06F 3/067

(57) ABSTRACT

Methods and systems for reallocating requests in a virtual volume storage provider to leverage underutilized resources are provided. An active node in an active-standby node pair configuration receives a request from a virtual machine monitor. The active node classifies the incoming request according to an allocation policy. If the request satisfies the allocation policy, the active node redirects the request to the standby node for execution. The request response is returned from the standby node to the active node. The active node redirects the response to the virtual machine monitor.

### BACKGROUND

Virtual volume storage providers provide and manage storage objects called virtual volumes. Virtual volume-based virtual machines (VMs) offer granular level data service management which makes the model a preferred implementation for the information technologies (IT) infrastructure provider, especially private cloud-like environments. In recent times, virtual volume models have seen a surge in their adoption becoming a storage model of choice. Many users are upgrading from a traditional virtual machine file system (VMFS) datastore to virtual volume-backed datastores. Virtual volume storage providers are chatty in nature, and as such, query calls in a scale environment tend to overwhelm the virtual volume storage provider, overshadowing critical application programming interface (API) services for create, read, update, delete (CRUD) operations. Active virtual volume storage providers spend a lot of time servicing the query calls, thereby causing a dip in performance for critical operations in a scale environment. The performance dip presents a challenge and is a roadblock for users moving from traditional VMFS to a virtual volume model.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method may include receiving a request to a first node of a storage provider pair from a virtual machine monitor and classifying the request according to an allocation policy. The request may be redirected to a second node of the storage provider pair when the request satisfies the allocation policy. The second node may be instructed to execute the request using at least one resource of the second node. A response to the request may be received from the second node. The response to the request may be directed to the virtual machine monitor.

The method may include, alone or in combination, one or more of the following features. The request may be a read operation. The first node may be configured as an active node of a virtual volume storage provider. The second node may be configured as a standby node of the virtual volume storage provider. The request may be a query related to a virtual volume. The allocation policy may comprise an operation list, wherein classifying the request comprises identifying the request in the operation list. The request may be classified as one of a create, read, update or delete operation, wherein the allocation policy is satisfied by a read operation. The request may comprise an application programming interface (API).

According to another aspect, a system may include a memory and at least one processor that is operatively coupled to the memory, the at least one processor being configured to perform the operations of receiving a request to a first node of a storage provider pair from a virtual machine monitor and classifying the request according to an allocation policy. The request may be redirected to a second node of the storage provider pair when the request satisfies the allocation policy. The second node may be instructed to execute the request using at least one resource of the second node. A response to the request may be received from the second node. The response to the request may be directed to the virtual machine monitor.

The system may include, alone or in combination, one or more of the following features. The request may be a read operation. The first node may be configured as an active node of a virtual volume storage provider. The second node may be configured as a standby node of the virtual volume storage provider. The request may be a query related to a virtual volume. The allocation policy may comprise an operation list, wherein classifying the request comprises identifying the request in the operation list. The request may be classified as one of a create, read, update or delete operation, wherein the allocation policy is satisfied by a read operation. The request may comprise an application programming interface (API).

According to another aspect, a non-transitory computer-readable medium may one or more processor-executable instructions, which when executed by at least one processor causes the at least one processor to perform the operations of receiving a request to a first node of a storage provider pair from a virtual machine monitor and classifying the request according to an allocation policy. The request may be redirected to a second node of the storage provider pair when the request satisfies the allocation policy. The second node may be instructed to execute the request using at least one resource of the second node. A response to the request may be received from the second node. The response to the request may be directed to the virtual machine monitor.

The computer-readable medium may further include, alone or in combination, one or more of the following features. The first node may be configured as an active node of a virtual volume storage provider and the second node may be configured as a standby node of the virtual volume storage provider. The allocation policy may comprise an operation list, wherein classifying the request comprises identifying the request in the operation list. The one or more processor-executable instructions may cause the at least one processor to perform the operation of classifying the request as one of a create, read, update or delete operation, wherein the allocation policy is satisfied by a read operation.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a storage system 100, according to aspects of the disclosure;

FIG. 2 is a diagram of an example of a storage processor, according to aspects of the disclosure;

FIG. 3 is a diagram of an example of a virtual provider node pair storage system, according to aspects of the disclosure;

FIG. 4 is a flow diagram of a method of processing a computing request, according to aspects of the disclosure; and

FIG. 5 is a diagram of an example of a computing device, according to aspects of the disclosure.

### DETAILED DESCRIPTION

Aspects of the present disclosure provide methods and systems for reallocating requests in a virtual volume storage provider to leverage underutilized resources. An active node in an active-standby node pair configuration may receive a request from a virtual machine monitor. The active node may classify the incoming request according to an allocation policy. If the request satisfies the allocation policy, the active node may redirect the request to the standby node for execution. The request response is returned from the standby node to the active node. The active node may redirect the response to the virtual machine monitor.

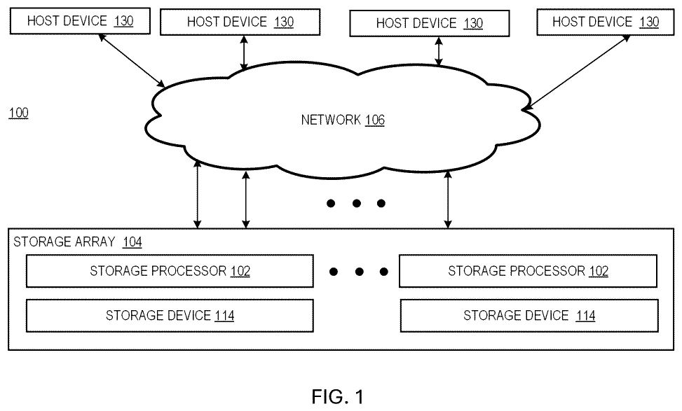

FIG. 1 is a diagram of an example of a storage system 100, according to aspects of the disclosure. As illustrated, the system 100 may include a storage array 104, a communications network 106, and a plurality of host devices 130. The communications network 106 may include one or more of a fibre channel (FC) network, the Internet, a local area network (LAN), a wide area network (WAN), and/or any other suitable type of network. The storage array 104 may include a storage system, such as DELL/EMC Powermax™, DELL PowerStore™, and/or any other suitable type of storage system. The storage array 104 may include or be arranged with one or more node-pairs and a plurality of non-volatile memory storage devices 114. Each node may be or include, as described herein, a virtual provider. Each node of the node pairs may include one or more storage processors 102. Each of the storage processors 102 may be configured to receive I/O requests from host devices 130 and execute the received I/O requests by reading and/or writing data to storage devices 114. Each of the host devices 130 may include a desktop computer, a laptop, a smartphone, an internet-of-things (IoT) device, and/or any other suitable type of computing device.

According to one aspect, each of storage devices 114 may be a non-volatile memory express (NVMe) drive. In another aspect, the storage devices may be solid-state drives (SSD). In some implementations, each of the storage devices 114 may be connected to the storage processors 102 via a Peripheral Component Interconnect Express (PCIe) connection. Each of the storage devices 114 may include a respective controller (not shown) and storage medium (not shown). The controller of each storage device 114 may include processing circuitry that is configured to perform various tasks, such as the retrieval and storage of data on the medium, wear leveling, error handling, garbage collection, as well as other functions. The medium may include an array of NAND memory cells and/or any other suitable type of storage medium.

In some implementations, any of the storage devices 114 may be internal to one of the storage processors 102 and coupled to the storage processor via an M.2 slot that is provided on the motherboard of that storage processor. Additionally, or alternatively, in some implementations, any of the storage devices 114 may be part of a disk array enclosure (DAE) and coupled to each of the storage processors 102 via a respective InfiniBand adapter of that storage processor. It will be understood that the present disclosure is not limited to any specific method for connecting storage devices 114 to storage processors 102.

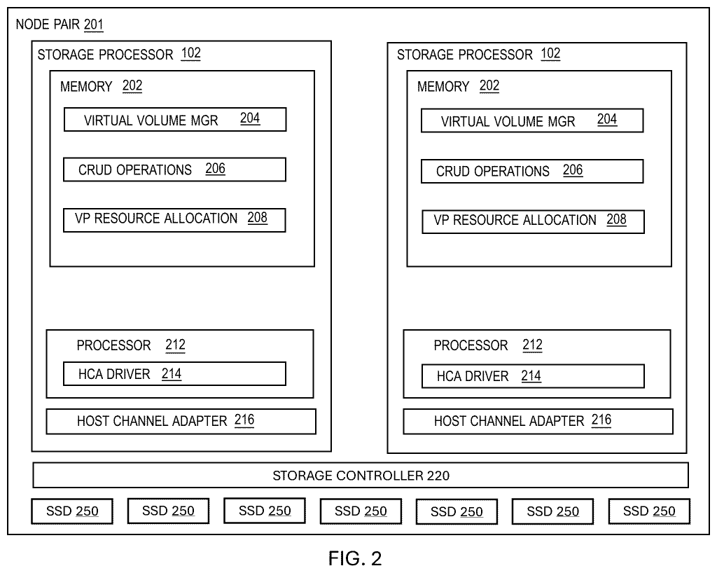

FIG. 2 is a diagram of a virtual provider node pair 201, according to aspects of the disclosure. The node pair 201 may be part of storage array 104. Each of the nodes in the pair may be or include virtual providers. The node pair 201 may include one or more storage processors 102 that are formed on the same motherboard, as well as one or more of the storage devices, for example SSD 250. One or more storage controllers 220 may provide an interface between the nodes and the SSDs 250. According to one aspect, incoming requests to a node may be sent to the storage controller to process the request and executing the operation on the SSD 250. The storage processors 102 and SSD 250 that constitute the node pair 201 may be disposed in the same housing enclosure, such as a disk array enclosure (DAE). In some implementations, the housing enclosure may be integrated into a server rack.

According to aspects of the disclosure, each storage processor 102 of the node pair 201 may include a memory 202, a processor 212, and a host channel adapter (HCA) 216. According to the present example, the HCA 216 may be an NVIDIA ConnectX-6™ HCA. The processor 212 may include any suitable type of processing circuitry, such as one or more of a general-purpose processor (e.g., an x86 processor, a MIPS processor, an ARM processor, etc.), a special-purpose processor, an application-specific integrated circuit (ASIC), a field programmable gate array (FPGA), etc. The memory 202 may include any suitable type of volatile and/or non-volatile memory, such as a solid-state drive (SSD), a hard disk (HD), a random-access memory (RAM), a Synchronous Dynamic Random-Access Memory (SDRAM), etc. The HCA 216 may be a circuit board or integrated circuit adapter that connects the storage processor 102 to the network 106 and the storage array 104 (shown in FIG. 1).

The memory 202 may be configured with a virtual volume manager 204, create, read, update, delete (CRUD) operations portion 206, and a virtual provider (VP) allocation policy 208. While each of the components are shown in FIG. 2 as a part of the memory 202, one skilled in the art will recognize that any of the components may be located outside of the memory 202 and in other components, circuitry or other structures accessible by the storage processor 102.

According to one aspect, as described herein, the storage processor 102 may be configured to allocate processing and memory resources of a virtual provider node to a second node to balance the workload across a virtual provider node pair. In a virtualization platform, like vSphere from VMWare, LLC, high-availability configurations may include one of two models of registering a virtual volume storage provider in a management utility. An “Active-Active” model, where both the virtual volume storage providers (e.g., virtual provider nodes) may be registered in the utility management as active providers. In this model, CRUD operations 206, may be done on both of the virtual volume storage provider nodes.

Another model may be an “Active-Standby” model where CRUD operations 206 may be executed by one active virtual volume storage provider node. A standby virtual volume storage provider node's only activity may be responding to a heartbeat request from the management utility so as to indicate its availability. If the active provider node goes down, the management utility may activate the standby provider node which then will start receiving CRUD operations 206 requests from the management utility.

In an embedded virtual volume storage provider environment, where provider nodes are registered as active-standby deployments, the resources allocated for the standby provider node are not leveraged until it becomes active. Even when the incoming load is increased, and thereby the need to increase resource availability arises, the virtual volume storage providers cannot utilize the resources of the underutilized standby provider node. In an embedded environment, computational resources may be limited. As such, efficient use of those resources is of real importance. Inefficient use of such resources may limit vertical scaling of the environment.

Currently, in an enterprise infrastructure, thousands of virtual machines (VMs) may be hosted and cloud computing is becoming a new normal. This may only increase storage object creation and management, further taxing computational resources. Control operations for these storage objects should be able to scale for number and response time.

According to one aspect, memory 202 may be configured with a virtual volume manager 204. The virtual volume manager 204 may be configured to process requests, including API calls, according to the VP resource allocation policy 208, as described herein. According to one aspect, the virtual volume manager 204 may use the VP resource allocation policy 208 to balance the workload across both nodes of the virtual provider node pair. As described herein, in an active-standby virtual provider model, the virtual volume manager 204 of an active node may redistribute incoming requests to the standby node, whose resources are underutilized. The standby node may then process the reallocated request by, for example, requesting or instructing the storage controller 220 to read or query a storage device, such as an SSD 250. The standby node may receive the response through the storage controller 220 and return the read response or query response back to the active node for transmission back to the management utility.

The processor 212 may execute a driver 214 for the HCA 216. The driver may be configured to, at least in part, manage a send queue as well as any other queues that are used by the storage processor 102 for the transmission of data via the HCA to either another node or to the SSD 250.

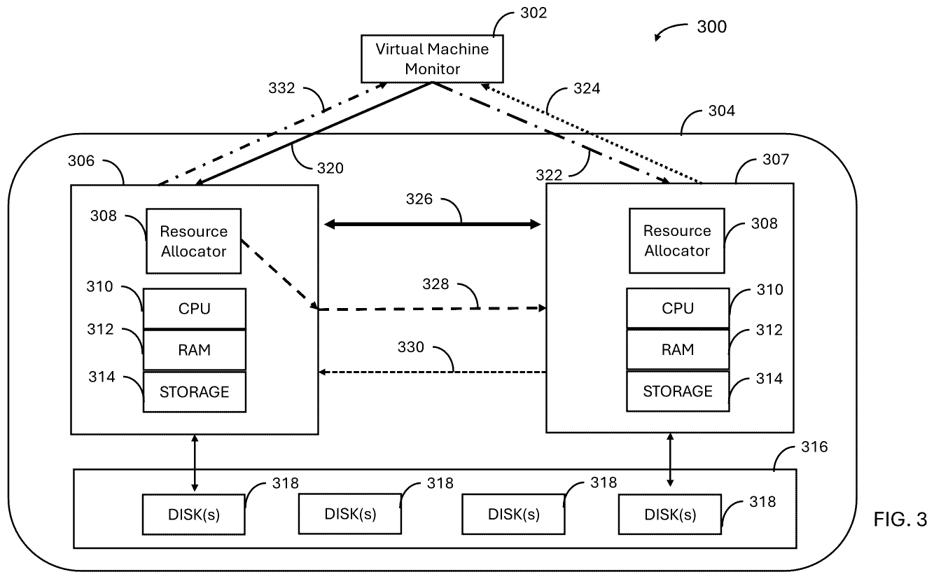

FIG. 3 is a diagram of an example of a virtual provider node pair storage system 300. According to one aspect, the system 300 may include a virtual machine monitor 302 configured with a management utility to direct and control storage operations of one or more virtual provider node pairs 304. The virtual node pair 304 may include a first node 306 and a second node 307. According to one aspect, the first node may be configured as an active node in an active-standby virtual volume storage provider model. The second node 307 may be configured as a standby node in the active-standby virtual volume storage provider model.

Each of the first node 306 and the second node 307 may include a resource allocator 308, a CPU 310, RAM 312, or other memory, and a local storage 314. The resource allocator 308 may be similar to, include, or be included in a virtual volume manager 204, shown in FIG. 2. Each node may further be connected to a storage array 316 or other storage device. The storage array 316 may be similar to the storage array 104 shown in FIG. 1. The storage array 316 may include one or more disks 318 configured as long term memory storage. The disks 318 may be similar to the storage devices 114, shown in FIG. 1.

According to one aspect, in an active-standby configuration, the virtual machine monitor 302 may only initialize the second node 307 as a backup provider when the active provider, such as the first node 306, fails. Until the active provider, the first node 306, fails, the standby provider, the second node 307, will be operational, however it may be underutilized, or not used at all. The second node 307 may respond to heartbeat requests 322 from the virtual machine monitor 302 indicating in its response 324 a readiness to take up the active role. The second node 307 may also respond to a one-time peer-discovery request 326 from the first node 306 during initialization. Otherwise, the second node 307 is largely inactive. According to one aspect, in a storage array in which each node has its own computational and storage resources, such as the first node 306 and the second node 307, resource allocation and balanced workload may be optimized by utilizing resources on the second node 307 to alleviate pressure on the first node 306 as the active node.

According to one aspect, the resource allocator 308 of the active first node 306 may allocate and use the system's resources efficiently and accommodate scaling to potential demand of virtual volume storage provider-backed cloud computing. The active provider, the first node 306, may use the resources available on the standby node, the second node 307, to execute certain functions, requests and queries received from the virtual machine monitor 302.

According to one aspect, the first node may identify itself to the standby provider, the second node 307, as a peer provider request 326 and use the services of the second node 307 for certain operations. When a request 320 from the virtual volume manager 302 is received at the first node 306, the resource allocator 308 may determine if the request may be offloaded to the second node 307. According to one aspect, only read functions of the CRUD operations may be reallocated. If the request is one that may be reallocated, the first node may send the reallocated request 328 to the second node 307. The previously unused processing and memory resources of the second node 307 may then execute the request querying the storage array 316. The second node 307 may receive and send the request response 330 a back to the first node 306. The first node 307 may forward the response 332 back to the virtual machine monitor 302.

According to one aspect, the operations available to allocate to the second node may include API functions including read-only requests or queries. The read-only nature of the requests ensures that offloading such queries may not disrupt the operations of the node pair. According to one aspect read-only APIs that the resource allocator 308 of the first node 306 may redirect to the second node 307 may include, for example: queryStorageContainer, queryStorageContainerForArray, query VirtualVolume, query VirtualVolumeInfo, spaceStatsForStorageContainer, spaceStatsFor VirtualVolume, unsharedChunks Virtual Volume, unsharedBitmap VirtualVolume, allocatedBitmap VirtualVolume.

Of these APIs, queryStorageContainer, queryStorageContainerForArray, query VirtualVolume, query Virtual VolumeInfo, spaceStatsForStorageContainer and spaceStatsForVirtualVolume calls may increase with the number of VMs, causing an increase in number of incoming requests to the virtual volume storage provider. Additionally, these APIs may be part of several workflows, such as VM creation, disk addition/deletion, VM migration, or the like. Redirecting these API calls to the second node 307 may allow the first node 306 as the active provider to take up more critical and time sensitive operations.

According to one aspect, other APIs, such as allocatedBitmap VirtualVolume, unsharedBitmap VirtualVolume and unsharedChunks VirtualVolume may be invoked during the VM migration of a powered-on VM, which is a time consuming workflow. Utilizing the second node 307 and its resources reduces the time and computational strain on the first node 306. A reduction in turn-around time for these APIs not only helps the virtual volume storage providers to manage their workload, it may also improve the time taken for a VM to be migrated from one datastore to another.

Accordingly, the ability to free up resources on the active first node 306 provides a practical solution to the problem of executing query calls by an active provider overshadowing other critical operations that only an active node may execute. According to one aspect, the reallocation of requests to the second node further avoids resource surplusage in the standby provider, effectively balancing a workload across the virtual provider node pair.

While the aspects of the present disclosure recite detail certain APIs, functions, and requests, particularly those associated with a VMware vSphere virtualization platform, one skilled in the art will recognize the present disclosure is not limited to only those APIs listed and other functions, calls, requests or the like, may be implemented in such a platform or another virtualization platform.

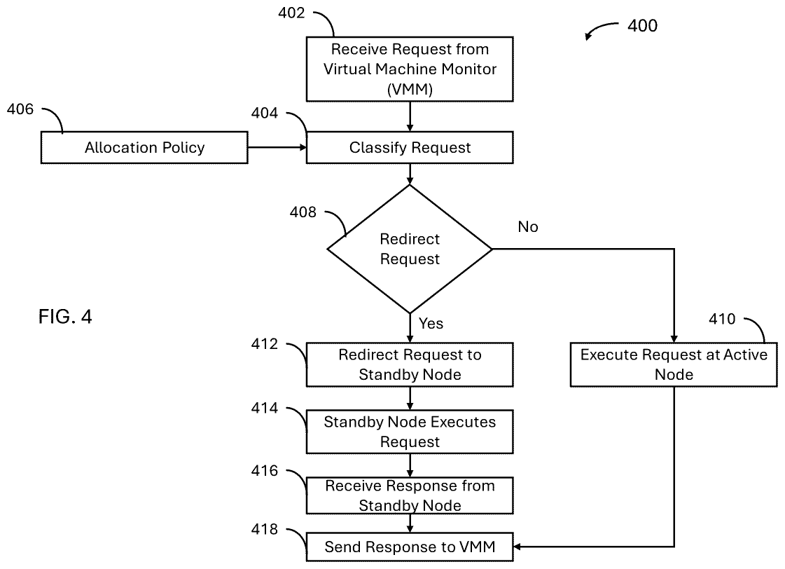

FIG. 4 is a flow diagram of a method of processing a computing request, according to aspects of the disclosure. As described herein, a first node of a virtual provider node pair may receive a request from a virtual machine monitor (VMM), shown in block 402. The first node may be an active node in an active-standby configuration of a virtual volume storage provider. As shown in block 404, the first node may classify the request according to an allocation policy, shown in block 406. The allocation policy may include rules or identification of functions, calls or other requests that may be reallocated to a second node, a standby node, of the virtual provider node pair. According to one aspect, the first node may classify the request as one of a CRUD operation, in which only a read operation may satisfy the allocation policy. As shown in block 408, the first node may determine whether the request is one that may be reallocated or one that should be processed by the active node itself. If the request is a write request, or any other request determined to be executed by the first node, the first node may execute the request, shown in block 410. The first node may send the request response to the VMM, shown in block 418.

If the first node determines that the request is one that may be reallocated to the second node, such as a read request, query or the like, the first node may redirect the request to the second node, shown in block 412 with an instruction to execute the request. The standby node, as shown in block 414 may execute the request freeing up resources on the first node. The standby node may send, and the first node may receive, the request response, as shown in block 416. The first node may forward the request response to the VMM, shown in block 418. Accordingly, the request has been processed using the resources of both virtual provider nodes.

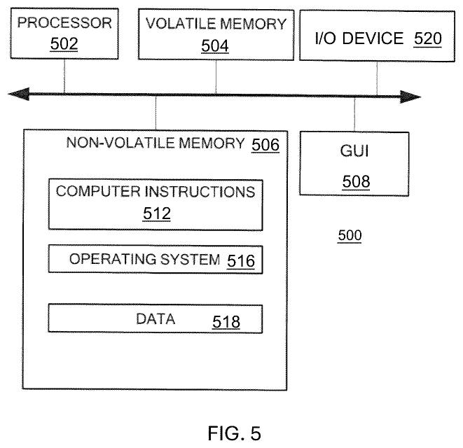

Referring to FIG. 5, in some embodiments, a computing device 500 may include processor 502, volatile memory 504 (e.g., RAM), non-volatile memory 506 (e.g., a hard disk drive, a solid-state drive such as a flash drive, a hybrid magnetic and solid-state drive, etc.), graphical user interface (GUI) 508 (e.g., a touchscreen, a display, and so forth) and input/output (I/O) device 520 (e.g., a mouse, a keyboard, etc.). Non-volatile memory 506 stores computer instructions 512, an operating system 516 and data 518 such that, for example, the computer instructions 512 are executed by the processor 502 out of volatile memory 504. Program code may be applied to data entered using an input device of GUI 508 or received from I/O device 520.

FIGS. 1-5 are provided as an example only. In some aspects or embodiments, the term “I/O request” or simply “I/O” may be used to refer to an input or output request. In some embodiments, an I/O request may refer to a data read or write request. At least some of the steps discussed with respect to FIGS. 1-5 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method comprising:
receiving a request to a first node of a storage provider pair from a virtual machine monitor;
classifying the request according to an allocation policy;
redirecting the request to a second node of the storage provider pair when the request satisfies the allocation policy;
instructing the second node to execute the request using at least one resource of the second node;
receiving a response to the request from the second node; and
directing the response to the request to the virtual machine monitor.

2. The method of claim 1 wherein the request is a read operation.

3. The method of claim 1 wherein the first node is configured as an active node of a virtual volume storage provider.

4. The method of claim 3 wherein the second node is configured as a standby node of the virtual volume storage provider.

5. The method of claim 1 wherein the request is a query related to a virtual volume.

6. The method of claim 1 wherein the allocation policy comprises an operation list, wherein classifying the request comprises identifying the request in the operation list.

7. The method of claim 1 further comprising classifying the request as one of a create, read, update or delete operation, wherein the allocation policy is satisfied by a read operation.

8. The method of claim 1 wherein the request comprises an application programming interface (API).

9. A system comprising:
a memory; and
at least one processor that is operatively coupled to the memory, the at least one processor being configured to perform the operations of:
receiving a request to a first node of a storage provider pair from a virtual machine monitor;
classifying the request according to an allocation policy;
redirecting the request to a second node of the storage provider pair when the request satisfies the allocation policy;
instructing the second node to execute the request using at least one resource of the second node;
receiving a response to the request from the second node; and
directing the response to the request to the virtual machine monitor.

10. The system of claim 9 wherein the request is a read operation.

11. The system of claim 9 wherein the first node is configured as an active node of a virtual volume storage provider.

12. The system of claim 11 wherein the second node is configured as a standby node of the virtual volume storage provider.

13. The system of claim 9 wherein the request is a query related to a virtual volume.

14. The system of claim 9 wherein the allocation policy comprises an operation list, wherein classifying the request comprises identifying the request in the operation list.

15. The system of claim 9 further comprising classifying the request as one of a create, read, update or delete operation, wherein the allocation policy is satisfied by a read operation.

16. The system of claim 9 wherein the request comprises an API.

17. A non-transitory computer-readable medium storing one or more processor-executable instructions, which when executed by at least one processor cause the at least one processor to perform the operations of:
receiving a request to a first node of a storage provider pair from a virtual machine monitor;
classifying the request according to an allocation policy;
redirecting the request to a second node of the storage provider pair when the request satisfies the allocation policy;
instructing the second node to execute the request using at least one resource of the second node;
receiving a response to the request from the second node; and
directing the response to the request to the virtual machine monitor.

18. The non-transitory computer-readable medium of claim 17 wherein the first node is configured as an active node of a virtual volume storage provider and the second node is configured as a standby node of the virtual volume storage provider.

19. The non-transitory computer-readable medium of claim 18 wherein the allocation policy comprises an operation list, wherein classifying the request comprises identifying the request in the operation list.

20. The non-transitory computer-readable medium of claim 18 wherein the one or more processor-executable instructions cause the at least one processor to perform the operation of classifying the request as one of a create, read, update or delete operation, wherein the allocation policy is satisfied by a read operation.
